(19) United States
(12) Patent Application Publication
(10) Pub. No.: US 2022/0376788 A1
(43) Pub. Date: Nov. 24, 2022

(54) LIGHT BASED CONTROL SYSTEM

(71) Applicant: FlowActive, Inc., Troy, NY (US)

(72) Inventors: Matthew Cusack, Troy, NY (US); Frank Lipowitz, Rexford, NY (US)

(21) Appl. No.: 17/664,121

(22) Filed: May 19, 2022

Related U.S. Application Data
(60) Provisional application No. 63/190,460, filed on May 19, 2021.

(51) Int. Cl. H04B 10/116; G01F 1/661; H04B 10/564; H04B 10/572

(52) U.S. Cl. CPC H04B 10/116; G01F 1/661; H04B 10/564; H04B 10/572

(57) ABSTRACT

A device configured to perform a task. The device includes an optical sensor configured to obtain light sequences from a camera flashlight (or other source) and convert the light sequences to electronic signals; a processor configured to receive the electronic signals from the optical sensor, detect electronic signals indicative of a predefined light sequence, and output control signals in response to detection of a predefined light sequence; and a controllable feature that is activated in response to the control signals from the processor.

### TECHNICAL FIELD

The subject matter of this invention relates to controllable devices and more particularly to a system and method that transmits an electromagnetic radiation pattern from a transmitter device (e.g., flashlight, camera, light moderated by hand or shutter, any portable or mobile computing device, etc.) to communicate with and/or control a receiver device via optical sensors.

### BACKGROUND

Mechanical switches/buttons on devices often fail over time in moist environments. Mechanical switches/buttons require an opening in device walls for a respective switch to function, and the opening poses a risk for device exposure to liquid, moisture, steam, humidity, etc., that can cause corrosion of metallic components or otherwise damage the device. Further, mechanical switches/buttons only have one functional capability—on or off—unless a sequence or duration of button presses are incorporated to expand functionality to anything more than a traditional on/off operation. As a further limitation, mechanical switches/buttons require an operator to locate the switch/button on the device.

### SUMMARY

A first aspect of the present invention includes a system and method that includes transmitting a sequence of light using a transmitter device such as, for example, a flashlight, light moderated by hand or shutter, camera or mobile computing device. The method includes receiving and processing the sequence of light using a receiver device that includes one or more components such as, for example, an optical sensor to yield an electronic (e.g., digital) signal corresponding to the sequence of light. The method includes executing a task using the receiver device based on the electronic signal yielded from processing the sequence of light.

In one aspect, a device is configured to perform a task, comprising: an optical sensor configured to obtain light sequences from a camera flashlight and convert the light sequences to electronic signals; a processor configured to receive the electronic signals from the optical sensor, detect electronic signals indicative of a predefined light sequence, and output control signals in response to detection of a predefined light sequence; and a controllable feature that is activated in response to the control signals from the processor.

In a further aspect, a device configured to perform a task, comprising: an optical sensor configured to obtain light sequences with a visible wavelength and convert the light sequences to electronic signals; a processor configured to receive the electronic signals from the optical sensor, detect electronic signals indicative of a predefined light sequence, and output control signals in response to detection of a predefined light sequence; a controllable feature that is activated in response to the control signals from the processor; and a waterproof or tamper proof encasement that contains the optical sensor, processor and controllable feature.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a perspective view of a receiver device and a transmitter device according to embodiments.

FIG. 2 shows a side view of a receiver device and a transmitter device according to embodiments.

FIG. 3 shows a light flash sequence according to embodiments.

FIG. 4 shows a light flash sequence according to embodiments.

FIG. 5 shows a method that includes communication between a receiver device and a transistor device to execute a task according to embodiments.

FIG. 6 shows a method that includes communication between a receiver device and a transistor device to execute a task according to embodiments.

FIG. 7 shows a computing system and related components according to embodiments.

FIG. 8 shows a client accessing a computing system and related components according to embodiments.

FIG. 9 shows a client executing actions on a computing system and related components according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Aspects of this disclosure describe a system that utilizes a controllable light source from a transmitter device (e.g., camera flash on a smart phone) to control a receiver device. In some aspects, the transmitter device utilizes an application (App) stored on the transmitter device to cause the flashlight to generate a defined sequence of light signals that can be directed by a user of the transmitter device at an optical sensor in the receiver device. The optical sensor receives the sequence of light signals and generates electronic signals to control a feature of the receiver device. In some further embodiments, the optical sensor is encased within a secure material that allows the light signals to pass, thus allowing the receiver device to be, e.g., waterproof, tamper proof, etc.

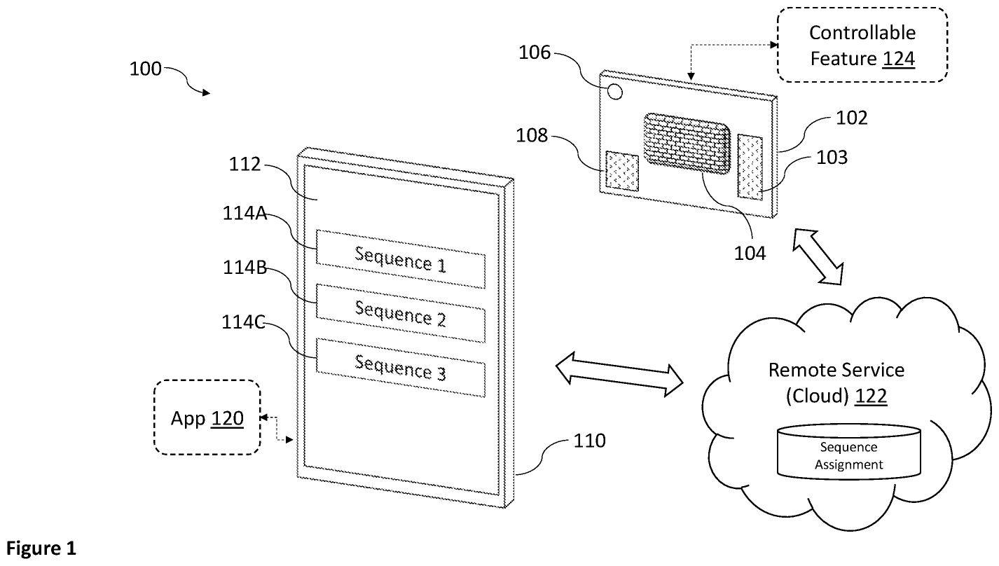

FIG. 1 shows an illustrative system 100 that includes a receiver device 102, a transmitter device 110, and a remote service 122, according to embodiments. In the present embodiment, receiver device 102 includes: an optical sensor 104 to convert electromagnetic radiation into electronic signals; an indicator 106, such as an LED, GUI output, audible output, tactile outputs, etc., to provide the status of receiver device 102 (e.g., active, ready, error, etc.); a power management unit 103 (e.g., a battery and associated control system); a microprocessor 108 that couples and controls components of receiver device 102; and one or more controllable features 124. Controllable features 124 may include any type of system or task, e.g., an electronic activation (e.g., switch on/off), a mechanical actuation, a communication (e.g., display data, output a sound, transmit data, etc.), etc.

Microprocessor 108 may include a set of program instructions to execute a task in response to receiving electronic signals from optical sensor 104. In some cases, the instructions (or aspects thereof) may be downloaded ahead of time from a remote services provider (e.g., a cloud) 122. In other cases, the instructions may be hardcoded (i.e., permanently stored) on the microprocessor 108. In other cases, the instructions may be preloaded from a device, such as the transmitter device 110. The program instructions may be configured to control the controllable feature 124, display information about receiver device 102 using, for example, feedback indicator 106 to display a color and/or sequence of lights according to the set of program instructions, manage power, or otherwise configure the receiver device 102, etc.

Transmitter device 110 is configured to transmit one or more light sequences to engage and control receiver device 102. In one illustrative embodiment, transmitter device 110 is a mobile computing device (e.g., smartphone) that includes a flashlight for an associated camera, and an interface 112 having one or more widgets or Apps 120 a user may engage to execute a respective light flash sequence to engage receiver device 102. App 120 may include a plurality of displayable widgets—e.g., widget 414A, widget 414B, and widget 414C— in which each widget triggers a light flash sequence in response to user engagement. Each widget of the plurality of widgets may trigger a unique light flash sequence corresponding to a specific task that receiver device 102 executes in response to receiving a respective unique light flash sequence—such as, e.g., engaging widget 114A triggers a first light flash sequence that corresponds to a first task (open the door), and widget 114B triggers a second light flash sequence that corresponds to a second task (lock the door), etc. Different tasks may be performed by a single receiver device 102 itself or by a set of different receiver devices (not shown).

App 120 can include various functionality, e.g., a user of the App may communicate with the remote services 122 to download App updates, obtain sequence information for one or more receiver devices, obtain instructions to generate predefined sequences, obtain a code to generate light sequences for a one-time operation or short term operations, e.g., control a lock to allow access to a home for a repair person. In other use cases, the App 120 may be configured to allow access, e.g., to a specified hotel room door for a particular period of time. In other use cases, the App 120 may include point of sale functionality that allows the user to purchase a code that triggers a defined light sequence to obtain a product from a vending machine, access a micro-mobility vehicle such as a BIRD or LIME scooter, charge a device at a charging station, etc.

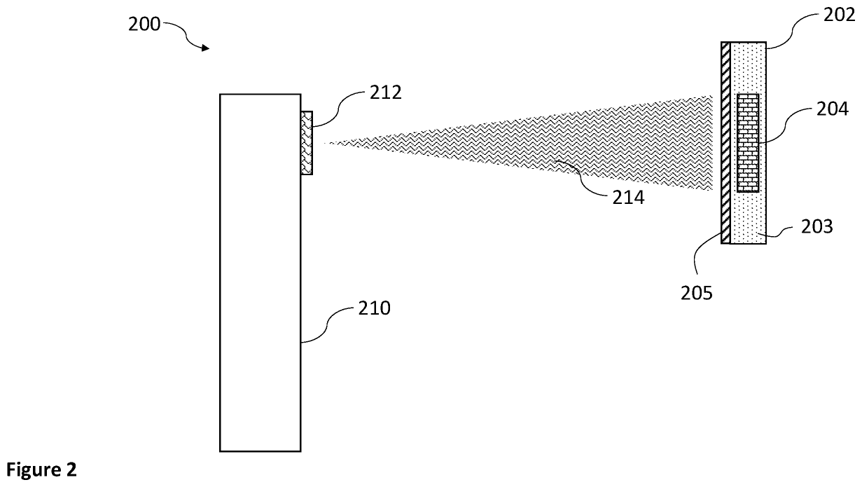

FIG. 2 shows a side view of an illustrative system 200 that includes receiver device 202 and transmitter device 210 according to embodiments. In the present embodiment, transmitter device 210 includes a light source 212 configured to transmit an electromagnetic wave 214. Light source 212 may include a camera flash or flashlight of a mobile computing device. Light source 212 may transmit electromagnetic wave 214 in response to engaging an App in the interface of transmitter device 210. Electromagnetic wave 214 may be one of a plurality of electromagnetic waves that light source 212 transmits in a light flash sequence. Electromagnetic wave 214 may include electromagnetic radiation having a wavelength, e.g., between 380 to 700 nm (i.e., visible light). Alternatively, transmitter device 210 may include a light source 212 configured to transmit an electromagnetic wave 214 that includes, e.g., radio waves, microwaves, infrared, visible light, ultraviolet, x-rays, and gamma rays.

In the receiver device 202, optical sensor 204 is configured to capture and process electromagnetic wave 214 to generate an electronic signal. Optical sensor 204 may be encased in the receiver device 202 with a translucent material 203 that allows light wave 214 to pass there through to the sensor 204. This thus allows the sensor 204 and other components of receiver 202 to operate in an airtight, waterproof, water resistant, tamper proof and/or sound proof, etc., environment. This may be particularly useful where receiver device 402 is in an outside environment subject to weather, a wet environment such as plumbing fixture, a submerged environment such as a pool or other body of water, an environment subject to toxic chemicals, etc. Translucent material 203 may encapsulate the entire receiver device 202 or a portion (e.g., a window). In some embodiments, the receiver device may comprise an Internet of Things device that, e.g., measures waterflow along a pipe or tube.

In some embodiments, receiver device 202 includes a light blocker 205 that limits certain light from entering the device, e.g., via polarization that absorbs light from a particular direction (e.g., horizontal light) and/or filtering that blocks unwanted wavelengths and/or passes desired wavelengths. For example, the UV rays of the sun (or other types of lighting) may inadvertently activate the sensor 204, which could interfere with the operation of the overall system. Light blocker 205 may thus be configured to block UV rays but allow other forms of light, e.g., light from a camera flash. Light blocker 205 may include any material, e.g., a clear coat epoxy, a film, a plastic shell, a shaded lens, glass, etc., that polarizes directional waves and/or filters certain light wavelengths. Light blocker 205 can be placed around the entire receiver device, around a portion of the device 202, or reside internally around the sensor 204. In some applications, transmitter device 210 can be configured to transmit selectable wavelengths of emitted light wave 214 that match with some light blockers 205 but not others, thus providing an extra level of security.

The encasement of the receiver device may utilize any semi-transparent or transparent material through which light may be transmitted. Depending on the thickness and light inhibiting factors such as opacity, a light pipe or light shield may be employed to concentrate or inhibit the light, so the proper amount is delivered to the sensor. Further, the light sensor can be designed based on the light-related physical parameters of the container. For example, if a plastic container is blue and absorbs a certain range of wavelengths, the sensor can be selected for the sensitivity that will successfully pass through the plastic.

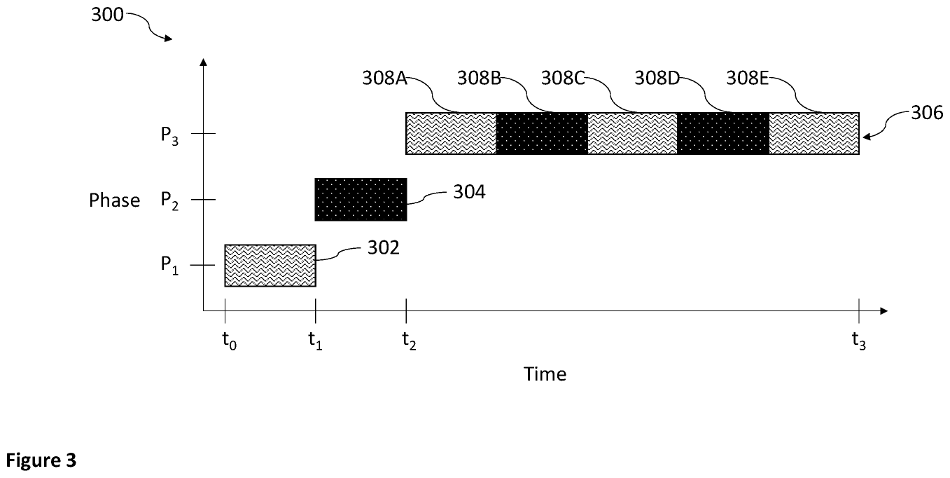

As noted, receiver devices can be uniquely controlled by utilizing predefined light sequences. FIG. 3 shows a timeline chart of an illustrative light flash sequence 300 according to embodiments. In this case, light flash sequence 300 includes three phases—phase one (P₁) 302, phase two (P₂) 304, and phase three (P₃) 306—occurring between time interval t₀ and t₃. P₁ 302 includes generating one flash of light between t₀ and t₁. P₁ 302 may include one or more flashes of light between t₀ and t₁. P₁ 302 may, e.g., be used to activate or turn on a receiver device, or prime a transmitter device light source. P₂ 304 includes a dark period of not generating light and thus not exposing a receiver device to light between t₁ and t₂. P₃ 306 includes three flashes of light—flash 308A, flash 308C, and flash 308E— between t₂ and t₃. P₃ 306 includes two dark periods— 608B and 608D— of not exposing a receiver device to light between t₂ and t₃. P₃ 306 may provide a predefined sequence of light that an optical sensor of a receiver device processes to yield an electronic signal that corresponds to a specific task. For example, an optical sensor may generate an electronic signal that includes a “1” for each flash of light in P₃ and a “0” for each period of no light exposure in P₃—e.g., 308A, 308B, 308C, 308D, 308E→10101. The electronic signal (e.g., 10101) may trigger execution of a corresponding task of a controllable feature using a microprocessor coupled to the optical sensor. In some cases, a first sequence of light signals might be used to wake up the receiver device from an off or sleep mode (using the power management unit). Then, and a brief delay, a second sequence of light signals might be outputted to effectuation a task by the receiver device. In some cases, the receiver device might output a status via an indicator during the process.

Any type of light sequence could be utilized. For example, P₃ 306 may include a varying number of flashes of light between t₂ and t₃ that each have properties (e.g., duration, intensity, frequency, etc.) independent of other flashes of light. For example, P₃ 306 may include nine flashes of light between t₂ and t₃ in which the first three flashes of light are each one second long, the second three flashes of light are each two seconds long, and the third three flashes of light are each three seconds long.

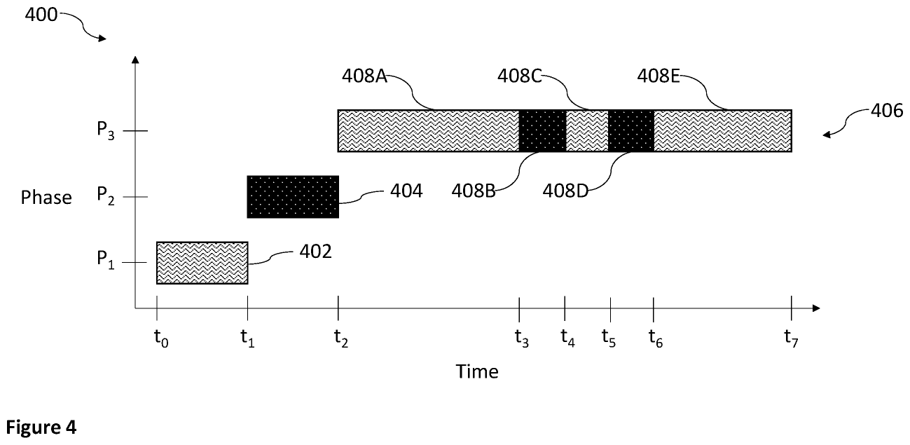

FIG. 4 shows a further example of a light flash sequence 400 according to embodiments. In this case, light flash sequence 400 includes three phases—phase one (P₁) 402, phase two (P₂) 404, and phase three (P₃) 406—occurring between time interval t₀ and t₇. P₁ 402 includes exposing a receiver device (not shown) to one flash of light between t₀ and t₁. P₁ 402 may include one or more flashes of light between t₀ and t₁. P₁ 402 may be used to activate or turn on a receiver device, or prime a transmitter device light source. P₂ 404 includes a dark period of not exposing a receiver device to light between t₁ and t₂. P₃ 406 includes three flashes of light—flash 408A, flash 408C, and flash 408E— between t₂ and t₇. In this case, flash 408A occurs for two seconds (2 s) between t₂ and t₃; flash 408C occurs for a half second (0.5 s) between t₄ and t₅; and flash 408E occurs for one and a half seconds (1.5 s) between t₆ and t₇. P₃ 406 includes two periods—408B and 408D—of not exposing a receiver device to light between t₃ and t₄, and between t₅ and t₆, for a half second each (0.5 s), respectively.

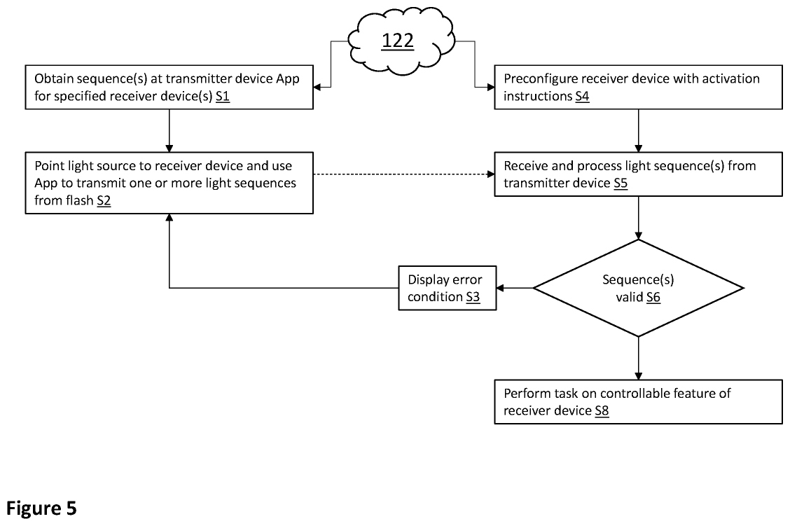

FIG. 5 depicts a flow diagram of an illustrative method. Initially, the transmitter device must obtain instructions for one or more light sequences for performing one or more tasks at a given receiver device at S1. Similarly, the receiver device must be preconfigured with activation instructions, i.e., what tasks to perform in response to received light sequences. For example, a hotel room door lock might be configured with two activation tasks, lock and unlock, that are activated with two different received sequences. In some cases, the receiver device need only be configured once during installation or during a reboot. In other cases, the receiver device might be configured regularly for better security. In the case of a hotel door lock, the transmitter device (e.g., a smartphone of the resident) may receive the necessary sequences at check-in that are time limited (e.g., until checkout). In other some cases, the sequence related information may be provided by remote service 122 that manages and tracks transmitter devices and receiver devices, e.g., when a user checks into a hotel, the service 122 provides instructions and/or sequence information to both devices.

In some cases, the same sequences generated by the transmitter device can be used to control multiple different receiver devices. In other cases, multiple different transmitter devices can be configured with the same sequence information to control a single receiver device.

Regardless, once the transmitter device is configured, a user of the device can point its associated light source at a receiver and use the interface (e.g., App) on the transmitter device to generate one or more light sequences, e.g., from the camera flash at S2. At S5, the receiver device receives the sequence(s) and processes them. If the received sequence(s) is valid (i.e., a recognized predefined sequence) at S6, then a task is performed by a controllable feature of the receiver device (e.g., unlock the door). If the sequence is not valid (i.e., not recognized), then an error condition can be displayed at the receiver device at S3 and the user can try again. In some cases, the predefined light sequence may comprise a sequence template, e.g., three initial flashes of a predetermined duration to wake the receiver device, then a varying number N of control flashes of the same or varying length, then three ending flashes of a predetermined duration. In this case, the information contained in the N control flashes could include a unique message or other data that, e.g., the user would like to display on the receiver device.

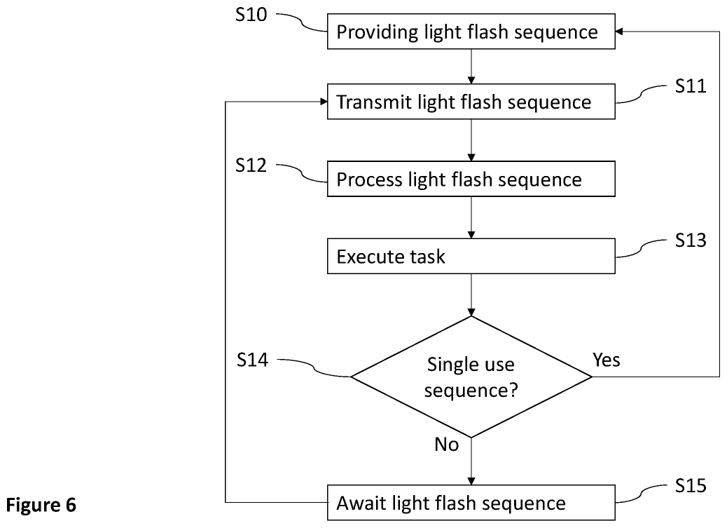

FIG. 6 shows a further method in which a light flash sequence is provided in step S10 at the transmitter device, which may include providing a sequence corresponding to a specific task or tasks or set of program instructions that a receiver device executes in response to exposure to said created sequence. This may include converting a digital signal (e.g., execution task identifier) to an analog signal (e.g., light flash sequence) that includes one or more flashes of light over one or more time intervals, and may include creating an analog signal based on quantity, intensity, wavelength and/or duration of light flashes over an interval.

At S11, the light is transmitted the light flash sequence is transmitted, e.g., a mobile computing device. This may include activating a light source component, or a plurality of light source components, of a transmitter device in a specific pattern in response to a user engaging an interface of a transmitter device and/or selecting one light flash sequence of a plurality of light flash sequences through an interface of the transmitter device.

At S12, the receiver device receives and processes the light flash sequence using an optical sensor—such as, e.g., a phototransistor. This may include processing an electromagnetic analog signal (e.g., light flash sequence) using a computer processor (e.g., microprocessor) that electrically couples to an optical sensor (e.g., photo cell or phototransistor) to yield a digital signal corresponding to a specific task or set of program instructions. This step may include measuring the quantity, intensity, wavelength, and/or duration of light flashes transmitted over one or more time intervals. This may include verifying that a generated digital signal is valid, or otherwise authorized, to be sent to the receiver device to trigger execution of a corresponding task.

At S13, a task is executed in response to processing the light flash sequence. This may include executing a set of program instructions stored in memory of a receiver device. This may also include activating one or more components electrically coupled to a computer processor of a receiver device pursuant to a set of program instructions that correspond to a digital signal yielded above. This may for example include querying a table or database to lookup a specific task. This can also include displaying a feedback signal using a feedback indicator (e.g., LED) to convey information pertaining to the receiver device such as, for example, receipt of instructions to execute a respective task.

S14 determines whether a light flash sequence is a single or multiple use sequence. This may include querying a database or metadata associated with the light flash sequence yielded above to determine whether a respective sequence may be used more than once to execute the task. If the light flash sequence is single use, then the method proceeds S10 to generate a new light flash sequence that a receiver device may receive and process to execute a task as previously discussed. If the light flash sequence is authorized for multiple uses, then the process proceeds and awaits receipt of the light flash sequence in step S15. This may include a receiver device waiting for a subsequent transmission of the light flash sequence in step S11.

In some embodiments, a system and method to communicate with and/or control a receiver device may include priming a transmitter device and/or turning on the receiver device with a first light flash sequence. The first light flash sequence may include a specific duration, intensity, frequency, etc., of one or more flashes of light emitted from a transmitter device. The method may include two or more light flash sequences having a specific duration, intensity, frequency, etc., of light from a transmitter device, or a light source electrically coupled to the transmitter device. A second light flash sequence may occur over a time interval of light or no light (e.g., a “read time window) after the first light flash sequence primes the transmitter device and/or turns on the receiver device. The method may include processing a second light flash sequence to yield a digital signal instructing a receiver device to execute a specific action or task. The method may include using the receiver device, or a device electrically coupled to the receiver device, to execute a specific action or task—such as, for example, unlocking/locking a door, configuring an electronic device, displaying the status of an electronic device, transmitting user data between two or more electronic device, etc.

In some embodiments, a method to control a receiver device may include assigning a unique light flash sequence to each user of a plurality of users authorized to access the receiver device using a transmitter device. The method may include recording a transaction between a receiver device and a transmitter device. A recorded transaction may include a timestamp, a unique light flash sequence emitted by a transmitter device, a user assigned to a respective unique light flash sequence, and/or an executed action or task. The method may include creating or modifying a user profile based on one or more transactions between a user and a receiver device. The method may include suggesting an action based on previous transactions between a user and a receiver device. The method may include creating or modifying a database that associates each user to a unique light flash sequence. The method may include storing a transaction, personal user information, or unique light flash sequences on a non-transitory computer readable medium.

In some embodiments, a method may include converting an analog signal—such as, for example, flash quantity and/or flash duration in a light flash sequence—to a digital signal. A light flash sequence may include a plurality of flashes over a time interval, in which an external component (e.g., a phototransistor) measures quantity, intensity, and/or duration of each light flash and processes measurements to yield a digital signal (e.g., binary numbers) corresponding to the light flash sequence. For example, a light flash sequence consists of five flashes—three flashes are ten seconds each and two flashes are five seconds each—and the duration of each flash measured to yield a “1” if the flash is ten seconds, or a “0” if the flash is five seconds. In this example, the light flash sequence yields “11100” which may be a digital signal instructing a receiver device to execute a specific task.

In some embodiments, a user engages a mobile application through a graphical user interface of a mobile computing device (i.e., a transmitter device) to interact with a receiver device. A mobile application may include a widget configured to trigger a light flash sequence through a light source component of the mobile computing device. A phototransistor or any other light sensitive detector may receive and process a light flash sequence emitted from a mobile computing device. A light flash sequence may be one of a plurality of sequences, each configured to trigger a response in a receiver device.

In some embodiments, a method of engaging a receiver device includes emitting a first light flash sequence to wake up or prime a transmitter device; waiting a prescribed or secret period with no light; and emitting a second light flash sequence to trigger a response in the receiver device. In the present embodiment, emitting the first light flash sequence turns on (or wakes it from a low power sleep mode) the light generating circuit on the transmitter device (e.g., the first light flash sequence “primes” the transmitter device). Waiting the period with no light may include not exposing the receiver device to a light flash sequence from the transmitter device. Emitting the second light flash sequence may include a transmitter device transmitting a specific sequence of light exposure that corresponds to a programmed task that a receiver device executes in response to receiving the specific sequence of light exposure. For example, a user engages a mobile application through a graphical user interface of a transmitter device to emit a first light flash sequence that includes a single flash of light for one second. The transmitter device ramps up its light generating circuitry so that subsequent light flashes transmit correctly. The transmitter device does not emit any light for a period of 2.5 seconds. Next, the transmitter device emits a second light flash sequence that includes three flashes of light for one second each. The receiver device converts the second light flash sequence (e.g., an analog signal) to a digital signal that instructs the receiver device to perform a corresponding task associated with the digital signal yielded from the second light flash sequence.

In some embodiments, a method to interact with a receiver device may include using a transmitter device to transmit a first light flash sequence in a low power state and transmit a second light flash sequence for a high power state. The method may include priming a transmitter device using a first light flash sequence that includes at least one flash of light. The method may include priming a transmitter device using a first light flash sequence in a lower power state to increase voltage prior to transmitting a second light flash sequence in a high power state. Priming a device may include increasing voltage using, for example, a charge pump circuit. For example, a transmitter device emits a first light flash sequence in a low power state that includes one flash of light for one second. The first light flash sequence primes the transmitter device using capacitors in a charge pump circuit to increase voltage output in the transmitter device. The transmitter device waits a prescribed period, and then emits a second light flash sequence in a high power state that includes three flashes of light for two seconds each. The second light flash sequence may include an encoded signal that instructs a receiver device to execute a specific task such as, for example, unlocking/locking a door.

In some embodiments, a method to interact with a receiver device includes generating a first light flash sequence that is “active” and will trigger an action by the receiver device in response to sensing the first light flash sequence. After triggering the action using a transmitter device, the first light flash sequence becomes “deactivated,” and the method may proceed to generating a second light flash sequence that is “active.” The method may include using a randomizer function, or processing an external data source, to generate a given light flash sequence that is “active.” The method may include a network component (e.g., a server, database, cloud, etc.) or wireless protocol (e.g., Wi-Fi, Bluetooth, 900 MHz, LoRaWAN, etc.) that enables a receiver device to communicate with a transmitter device regarding a status (e.g., active or inactive) of a given light flash sequence. The method may include using a computing device to generate a light flash sequence and transmitting the light flash sequence to other devices in a computing network such as, e.g., the receiver device and/or transmitter device. The method may include logging communication between a receiver device, a transmitter device, and other computing devices in a computing network.

In some embodiments, a system and method to interact with a receiver device may include using an algorithm (e.g., a cipher) to convert text characters to a light flash sequence. The method may include an algorithm that encodes each text character to a unique sequence of light that corresponds to a respective text character. The method may include an algorithm that encodes one or more text characters into one or more light flash sequences that a receiver device can measure based on quantity, duration, and/or intensity of flashes of light in a respective light flash sequence. For example, encoding the letter “X” may include a first flash of light for one second, absence of light for five seconds, and a second flash of light for two seconds. As such, encoding text characters “XX” yields a light flash sequence that includes a first flash of light for one second, absence of light for five seconds, a second flash of light for two seconds, a third flash of light for one second, absence of light for five seconds, and a fourth flash of light for two seconds.

In some embodiments, a receiver device may include a feedback indicator to communicate status of the receiver device through color and/or sequences—such as, e.g., a tone generator, speaker, or light-emitting diode (LED). A mobile application may display a color and/or sequence that a feedback indicator should communicate in response to triggering a respective light flash sequence. A receiver device may include a feedback indicator component—such as, e.g., an LED—configured to flash a number of times in response to sensing a light flash sequence produced by a transmitter device. The feedback indicator may identify a status of the receiver device, or otherwise convey information to a user about the receiver device. A receiver device may display a unique status sequence through a feedback indicator for each unique light flash sequence. For example, if a light flash sequence from a transmitter device includes a first number flashes, then an LED of a receiver device may display a status sequence that includes the first number of flashes.

In some embodiments, the receiver device, or a portion thereof, is sealed or encased in a waterproof (or water resistant) or temper proof container that includes a translucent exterior. Such a sealed container prevents internal components of the receiver device from exposure to the surrounding environment. The translucent exterior provides an optical path for light transmission to an optical sensor within said receiver device. This thus allows the optical sensor as well as any internal functionality (circuits, control systems, etc.) of the receiver device to be controlled in a closed environment. In other cases, the receiver device may reside in a vacuum. A tamper proof container may comprise any encasement that can not be readily opened without damaging or disabling the device.

In some embodiments, a receiver device may include a rigid exterior having a material (e.g., translucent color) transparent to certain light wavelengths, e.g., light emitted by a camera flash, flashlight, or other light source component, of a mobile computing device. For example, a receiver device may include an outer shell partially or fully made of ABS plastic in Pantone® 660C—e.g., RGB (64, 126, 201), HEX #407EC9. In some cases, the receiver device may include a translucent material with a maximum thickness, e.g., about 6 to 7 mm, to allow light to penetrate.

In some embodiments, a receiver device includes one or more ambient light or specific wavelength sensors enclosed within. The receiver device may include a phototransistor sensitive to light in the visible light spectrum—e.g., 380-700 nanometer (nm) wavelength range. A phototransistor enclosed within a receiver device may yield an analog output proportional to amount of light emitted. Alternatively, a receiver device may include a phototransistor component sensitive to light outside of the visible light spectrum—e.g., infrared light, 700-1000 nm wavelength range.

In some embodiments, a receiver device includes a phototransistor component positioned proximate to an inner surface of the receiver device. The phototransistor component may include a mount component to couple the phototransistor to an inner surface of the receiver device. For example, a 630 nm phototransistor is mounted to the interior of a receiver device about 22 millimeters (mm) from an inner surface of the receiver device.

In some embodiments, a light source component of a transmitter device must be aligned with, or proximate to, a receiver device to trigger sensors enclosed within a receiver device. A receiver device may limit false triggers from external light sources by requiring that a light source be aligned with, or proximate to, the receiver device.

In some embodiments, a transmitter device may be positioned between about 0-150 mm from an outer wall surface of a receiver device to accurately transmit a light flash sequence to the receiver. The distance between a transmitter device and a receiver device may however depend on strength of a light source component of the transmitter device, type of sensor used, and surface material of the receiver device. The transmitter device may be a mobile computing device, such as a mobile phone, that includes a light source. Such a transmitter device often includes a light source that yields between about 1-300 lumens. However, transmitter devices may include other types of light sources that, e.g., can yield up to about 1000 lumens.

In some embodiments, a receiver device may include a control system that involves any type of mechanical actuation, such as locking devices; an electronic device that requires access, configuration or calibration prior to use (e.g., a computer, an Ethernet router, medical instruments, clothes washer/dryer), or an electronic device that displays a status (e.g., automotive technician assessing on-board diagnostics, solar charge controller, weather monitoring station). A receiver device may be deployed to secure access to a location or other device—such as, e.g., a lock on a door or container. The receiver device may randomly generate a light flash sequence to access the receiver device.

In some embodiments, a receiver device may be installed on a piece of hardware or equipment that is accessed by multiple users—such as, e.g., vacation rental properties, hotels, automobile rentals, medical equipment, construction equipment, plant equipment, etc. Access to a receiver device may require a light flash sequence that changes between two or more users to prevent unauthorized access. The receiver device may include a plurality of light flash sequences in which a subset of the plurality of light flash sequences are active, such that only an active light flash sequence triggers a response from the receiver device. The active light flash sequence may rotate after each use, between users, or on some other rotation schedule, that determines which light flash sequence is active at a given time. For example, a hotel may install a receiver device on a hotel door and require hotel guests to use a mobile application on a mobile computing device to unlock the hotel door with a light flash sequence. A first hotel guest may use a first light flash sequence to access the hotel door. After the first hotel guest checks out, the first light flash sequence is “deactivated,” and a second light flash sequence is “activated” such that the receiver device will only respond to the second light flash sequence to access the hotel door. A second hotel guest may use the second light flash sequence to access the hotel door.

In some embodiments, a receiver device dynamically generates a light flash sequence after each use. The receiver device may communicate with a transmitter device to transmit a dynamically generated light flash sequence. The receiver device may communicate with a transmitter device through a network component (e.g., a server) to provide a dynamically generated light flash sequence that the receiver device will respond too.

In some embodiments, the receiver device includes a headless network appliance such as a router or an Internet of Things device such as a waterflow sensor. In certain cases, the light sequence is utilized to configure or otherwise active or set up the device. For example, an IoT device may be shipped in a standby mode and once installed needs to be activated for use. Rather than deploying an expensive Bluetooth or wireless platform to activate the device, it can be activated with a simple light sequence.

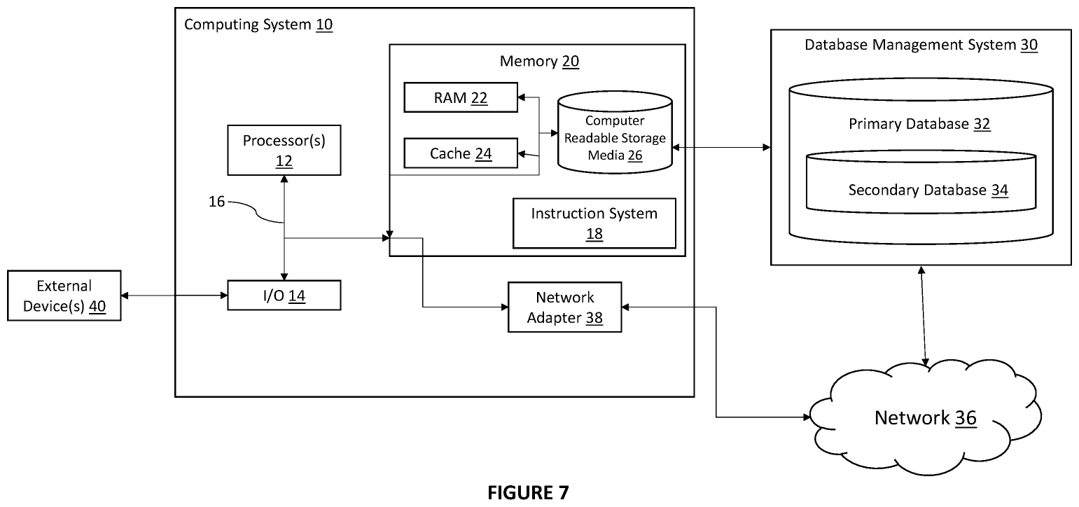

Aspects of the transmitter device and receiver device may be implemented using any known type of computing system. FIG. 7 depicts a computing system 10 that may comprise any type of computing device and for example includes at least one processor 12, memory 20, an input/output (I/O) 14 (e.g., one or more I/O interfaces and/or devices), and a communications pathway 16. In general, processor(s) 12 execute program code which is at least partially fixed in memory 20. While executing program code, processor(s) 12 can process data, which can result in reading and/or writing transformed data from/to memory and/or I/O 14 for further processing. The pathway 16 provides a communications link between each of the components in computing system 10. I/O 14 can comprise one or more human I/O devices, which enable a user to interact with computing system 10. Computing system 10 may also be implemented in a distributed manner such that different components reside in different physical locations.

Furthermore, it is understood that the instruction system 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

It is understood that instruction system 18 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

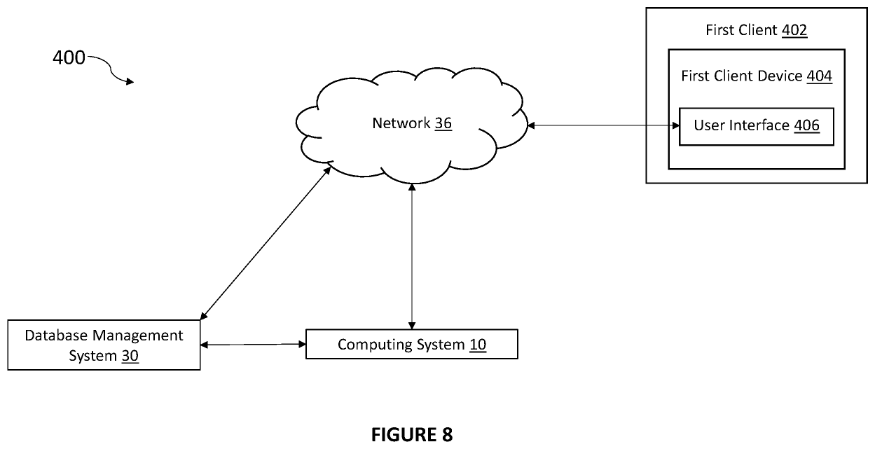

FIG. 8 depicts a diagram 400 of a first client 402 (e.g., a transmitter device or receiver device) interacting with a network 36 (e.g., a remote service) through a first client device 404 through a user interface 406. In the present embodiment, the user interface 406 is a web application that is accessible through the network 36. The computer program product may be stored and executed by computing system 10. The web application relies on data stored in database management system 30. The first client 402 interacts with the first client device 404 to access the web application through user interface 406. The web application, accessed through user interface 406, allows the first client to access resources on computing system 10 and database management system 30.

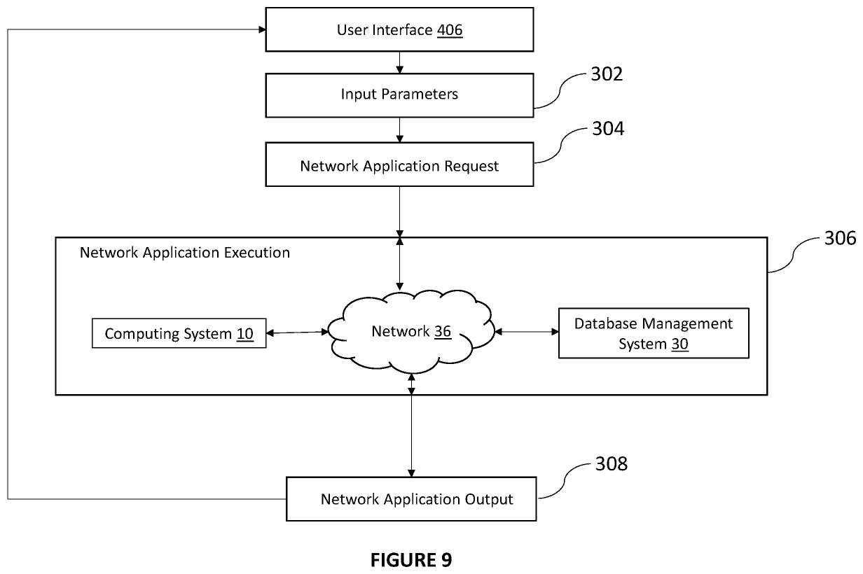

FIG. 9 depicts a flow diagram of a first client 402 interaction with user interface 406. In the present embodiment, the first client 402 accesses the user interface 406. The first client 402 inputs and/or selects a plurality of input parameters 302 through user interface 406. The input parameters 302 are parsed and/or formatted as a network application request 304. The network application request 304 is sent to network 36 to carry out a network application execution 306. The network application execution 306 is further comprised of network 36, computing system 10, and database management system 30. The network application execution utilizes a computer program, or plurality of computer programs, that are stored and carried out by computing system 10. The computer program, or plurality of computer programs, utilizes one or more aspects of the database management system 30 to facilitate the network application execution 306.

Subsequently, the network application execution 306 generates a network application output 308 through network 36 through database management system 30 through computing system 10. The network application output 308 is the response returned based on the network application request 304 generated by input parameters 302 and carried out by network application execution 306. The network application output 308 is transmitted and available to the first client 402 through the user interface 406.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A device configured to perform a task, comprising:
an optical sensor configured to obtain light sequences from a camera flashlight and convert the light sequences to electronic signals;
a processor configured to receive the electronic signals from the optical sensor, detect electronic signals indicative of a predefined light sequence, and output control signals in response to detection of a predefined light sequence; and
a controllable feature that is activated in response to the control signals from the processor.

2. The device of claim 1, further comprising a waterproof encasement that holds the optical sensor and processor.

3. The device of claim 2, wherein the waterproof encasement includes a translucent surface area configured to pass flashlight signals to the optical sensor.

4. The device of claim 1, further comprising a feedback indicator configured to indicate a status.

5. The device of claim 1, further comprising a power management system that includes a low power state and a high power state.

6. The device of claim 5, wherein the power management system transitions from the low power state to the high power state in response to an initial detected light sequence.

7. A device configured to perform a task, comprising:
an optical sensor configured to obtain light sequences with a visible wavelength and convert the light sequences to electronic signals;
a processor configured to receive the electronic signals from the optical sensor, detect electronic signals indicative of a predefined light sequence, and output control signals in response to detection of a predefined light sequence;
a controllable feature that is activated in response to the control signals from the processor; and
a waterproof encasement that contains the optical sensor, processor and controllable feature.

8. The device of claim 7, wherein the device measures waterflow.

9. The device of claim 7, wherein the waterproof encasement includes a translucent surface area configured to pass light sequences to the optical sensor.

10. The device of claim 7, further comprising a feedback indicator configured to indicate a status.

11. The device of claim 7, further comprising a power management system that includes a low power state and a high power state.

12. The device of claim 11, wherein the power management system transitions from the low power state to the high power state in response to an initial detected light sequence.

13. The device of claim 7, further comprising a light blocker that limits certain light from entering the device.

14. The device of claim 13, wherein the light blocker includes polarization that absorbs light from a particular direction.

15. The device of claim 13, wherein the light blocker includes a light filter that blocks predetermined light wavelengths.

16. A device configured to perform a task, comprising:
an optical sensor configured to obtain light sequences with a visible wavelength and convert the light sequences to electronic signals;
a processor configured to receive the electronic signals from the optical sensor, detect electronic signals indicative of a predefined light sequence, and output control signals in response to detection of a predefined light sequence;
a controllable feature that is activated in response to the control signals from the processor; and
a tamper proof encasement that contains the optical sensor, processor and controllable feature.

17. The device of claim 16, wherein the tamper proof encasement cannot be opened without disabling the device.
